(19) United States
(12) Patent Application Publication
(10) Pub. No.: US 2017/0019859 A1
(43) Pub. Date: Jan. 19, 2017

(54) POWER MANAGEMENT METHOD BY PROVIDING POWER ACCORDING TO POWER ALLOCATION FOR IMPROVING POWER CONSUMPTION

(71) Applicant: MEDIATEK INC., Hsin-Chu (TW)

(72) Inventors: Chung-Hua Yu, Kaohsiung City (TW); Yong-Sheng Lo, Taichung City (TW); Chia-Lin Lu, Kaohsiung City (TW); Szu-Han Lee, Hsinchu City (TW); Shih-Hsin Chen, Hsinchu County (TW)

(21) Appl. No.: 15/209,721

(22) Filed: Jul. 13, 2016

Related U.S. Application Data
(60) Provisional application No. 62/193,821, filed on Jul. 17, 2015.

(51) Int. Cl. H04W 52/02

(52) U.S. Cl. CPC H04W 52/0261; H04W 52/0229

(57) ABSTRACT

A power management method includes providing status information of an external module to an intermediary module for updating status data; accessing updated status data via the intermediary module; determining a power value according to the updated status data; determining power allocation according to at least the power value; and providing power to the external module according to the power allocation.

### CROSS REFERENCE TO RELATED APPLICATIONS

This application claims the benefit of U.S. provisional application No. 62/193,821 filed Jul. 17, 2015. The above-mentioned application is included in its entirely herein by reference.

### BACKGROUND

Mobile devices such as a smart phone and a cellular tablet are becoming more and more popular, and a prolonged standby time of a mobile device is an approach to an improved user experience. A longer standby time can reduce a user's trouble to charge a mobile device frequently and can avoid out of battery quickly while using the mobile device. Presently, manufacturers are striving to develop batteries with greater capacity or merely set the mobile devices in an idle mode when they are not in use, but the effect of reducing power consumption is still very limited. In order to maintain operations of the mobile devices, sufficient power is supplied to the mobile devices all the time, making the mobile devices very power inefficient.

### SUMMARY

An embodiment of the present invention discloses a power management method including providing status information of an external module to an intermediary module for updating status data; accessing updated status data via the intermediary module; determining a power value according to the updated status data; determining power allocation according to at least the power value; and providing power to the external module according to the power allocation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a power management system according to an embodiment of the present invention.

FIG. 2 illustrates a flow chart of a power management method according to an embodiment of the present invention.

FIG. 3 illustrates a power management system according to an embodiment of the present invention.

FIG. 4 illustrates a corresponding chart between the intermediary module, the control module, and a modem using a CDMA2000 communications protocol according to an embodiment of the present invention.

FIG. 5 illustrates a power management system according to an embodiment of the present invention.

FIG. 6 illustrates a power management system according to an embodiment of the present invention.

FIG. 7 illustrates a power management system according to an embodiment of the present invention.

FIG. 8 illustrates a flow chart of a power management method according to an embodiment of the present invention.

### DETAILED DESCRIPTION

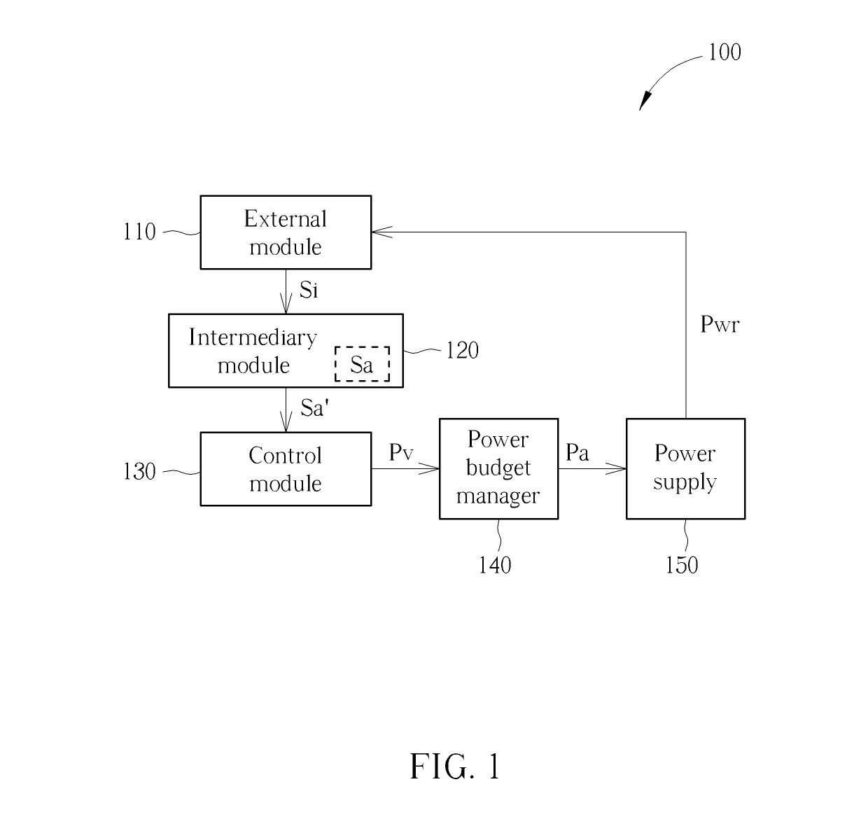

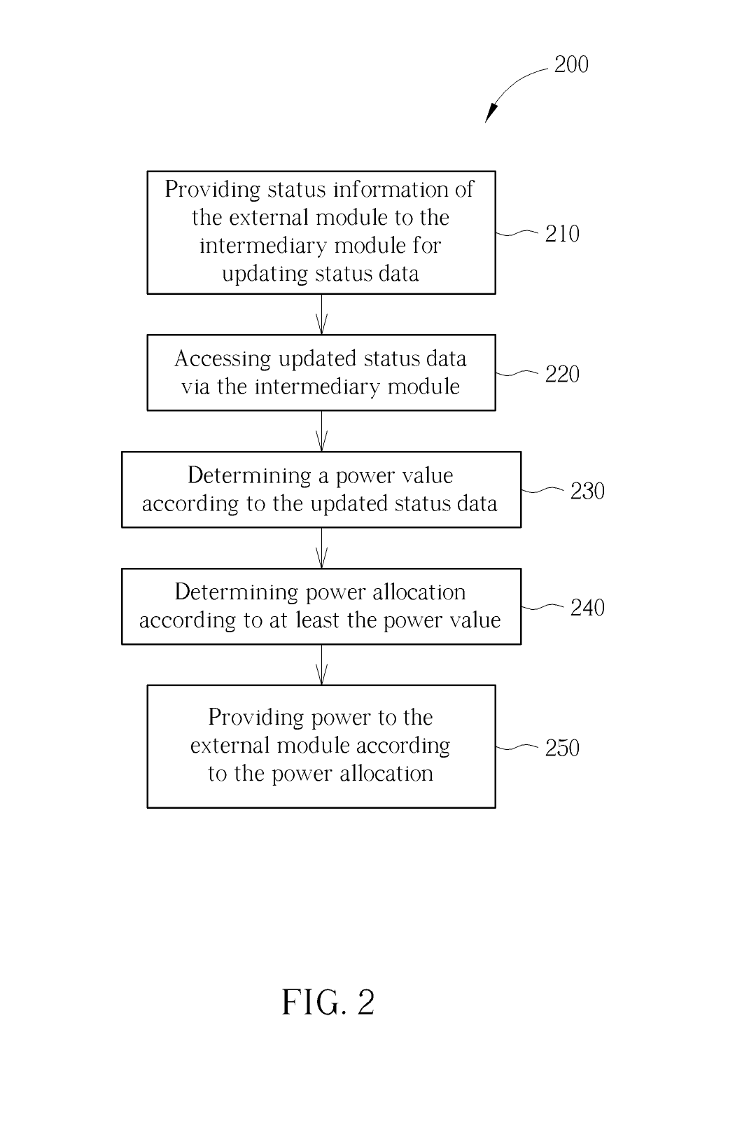

FIG. 1 illustrates a power management system 100 according to an embodiment of the present invention. The power management system 100 may include an external module 110, an intermediary module 120, a control module 130, a power budget manager 140 and a power supply 150. FIG. 2 illustrates a flow chart of a power management method 200 according to an embodiment of the present invention. Taking the power management system 100 for example, the power management method 200 may include the following steps:

Step 210: providing status information Si of the external module 110 to the intermediary module 120 for updating status data Sa;

Step 220: accessing updated status data Sa′ via the intermediary module 120;

Step 230: determining a power value Pv according to the updated status data Sa′;

Step 240: determining power allocation Pa according to at least the power value Pv; and

Step 250: providing power Pwr to the external module 110 according to the power allocation Pa.

In step 210, the intermediary module 120 may store the status data Sa, the external module 110 may provide the status information Si to the intermediary module 120, and the status data Sa is updated according to the status information Si so as to have the updated status data Sa′. In steps 220 and 230, the control module 130 may access the updated status data Sa′ via the intermediary module 120 and determine the power value Pv according to the updated status data Sa′. In steps 240 and 250, the power budget manager 140 may receive the power value Pv and determine the power allocation Pa according to at least the power value Pv, and the power supply 150 may provide power Pwr to the external module 110 according to the power allocation Pa. FIG. 1 may be an example of performing the power management method 200, but the power management method 200 is not limited to be performed with the power management system 100. According to embodiments of the present invention, the intermediary module 120 may include a plurality of registers and/or a plurality of memory units for handshaking and data storage as described below. It is within the scope of an embodiment of the present invention to use power management systems with other configurations to perform the power management method 200. For example, the power budget manager 140 and the power supply 150 may be integrated in one. In another example, the intermediary module 120 and the control module 130 may be integrated in one module. In addition to the power value Pv, the power budget manager 140 may determine the power allocation Pa according to other system status information collected from other functional modules or operating instructions (e.g. instructions generated by a central processing unit or manual setting) according to an embodiment of the present invention.

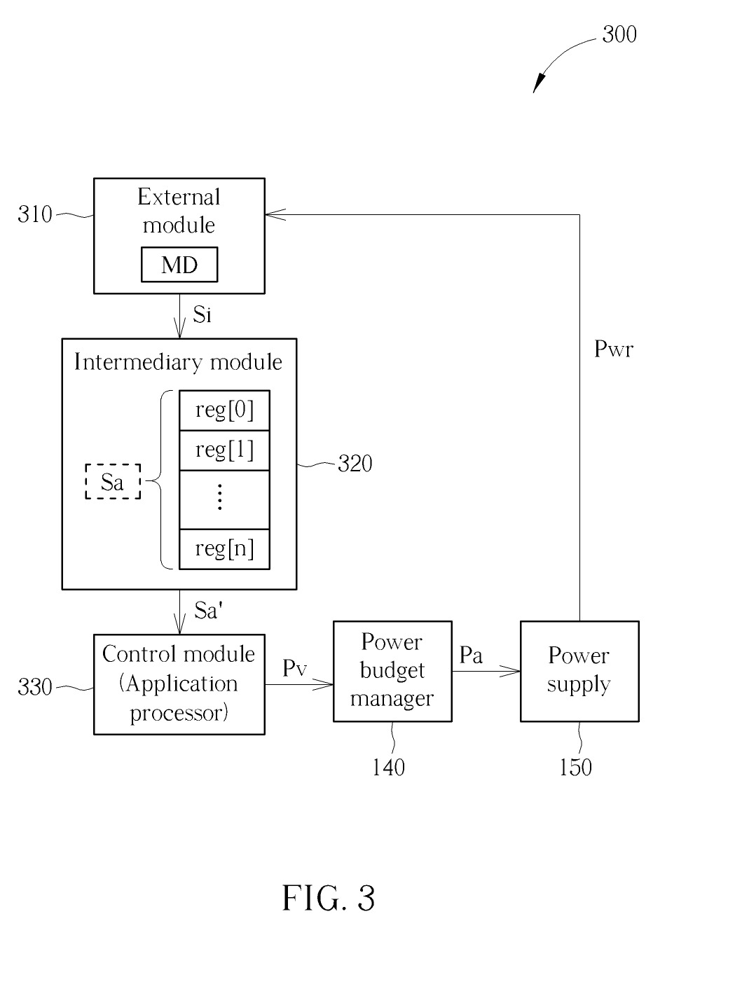

FIG. 3 illustrates a power management system 300 according to an embodiment of the present invention. The power management system 300 includes an external module 310 acting as at least a modem MD, an intermediate module 320 including a plurality of registers reg[0]-reg[n], a control module 330 acting as an application processor (AP), a power budget manager 140 and a power supply 150. The power budget manager 140 maybe a power management integrated circuit (PMIC). Similar to the power management system 100, the external module 310 may provide the status information Si, and the status information Si may correspond to a communications protocol used by the modem MD. The communications protocol used by the modem MD may be a second-generation (2G) wireless communications protocol, a third-generation (3G) wireless communications protocol, or a fourth-generation (4G) wireless communications protocol such as Worldwide Interoperability for Microwave Access (WiMAX®) or Long Term Evolution (LTE®) protocols. In another case, The communications protocol used by the modem MD may be CDMA2000 (C2K) protocol in some regions/countries. The status data Sa may be stored in the plurality of registers reg[0]-reg[n] of the intermediary module 320.

According to an embodiment of the present invention, a modem MDa may act as the modem MD of FIG. 3.According to the embodiment of FIG. 3, part of the registers reg[0]-reg[n] maybe used for setting the 4G communications protocol, another part of the registers reg[0]-reg[n] may be used for setting 2G communications protocol, yet another part of the registers reg[0]-reg[n] may be used for setting the 3G communications protocol, and still another part of the reg[0]-reg[n] may be preserved for setting emergency communication. The protocol used by the external module 310, for example, a modem MDa, may be determined by the control module (AP) 330. The determination of the protocol used by the modem MDa may be described as a scenario determination.

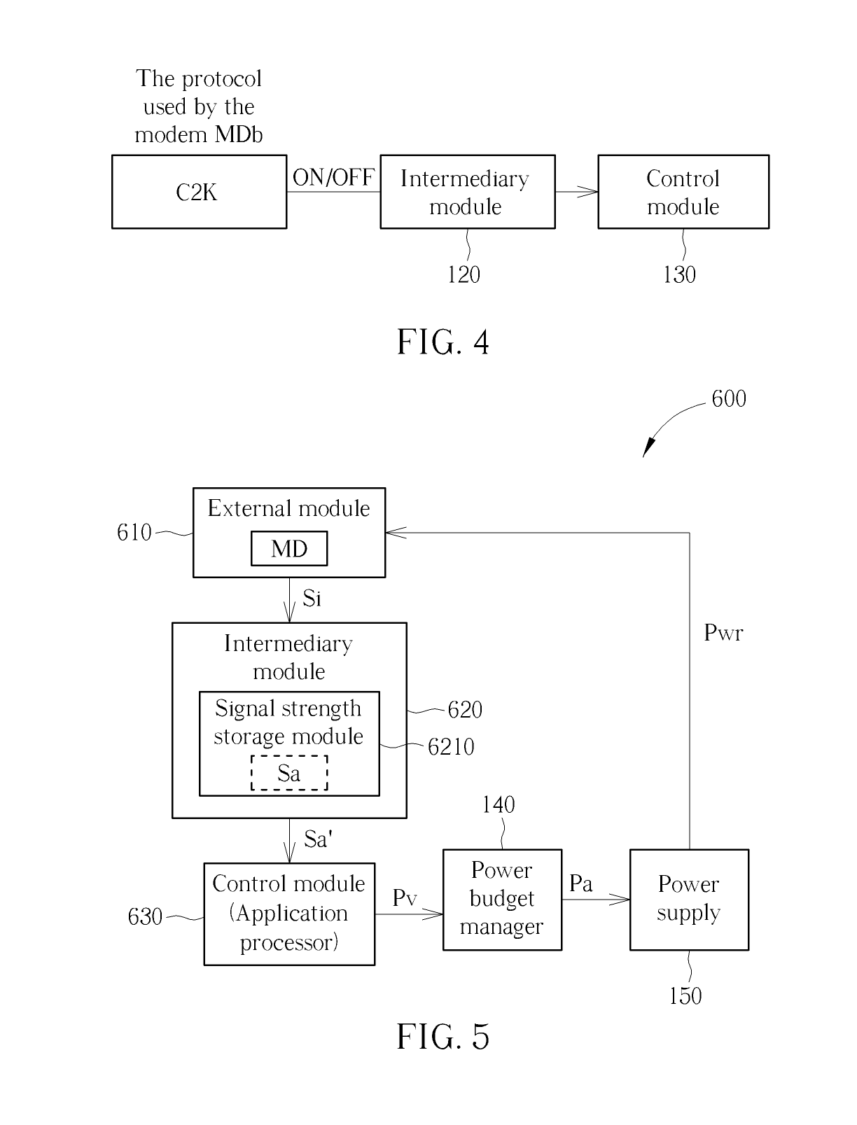

FIG. 4 illustrates a corresponding chart between the intermediary module 120, the control module 130, and a modem MDb using a CDMA2000 communications protocol according to an embodiment of the present invention. FIG. 4 is a configuration taken as an example rather than limiting the scope of the present invention. The modem MDb of FIG. 4 is a modem supporting the CDMA2000 (C2K) protocol specifically. The modem MDb may act as the external module 110 of FIG. 1, and a handshaking may be made between the modem MDb and the control module 130 via the intermediary module 120. When the modem MDb is turned on, the control module 130 may be informed. Since the modem MDb is specifically designed to operate in the C2K protocol, it is unnecessary to determine which protocol is used by the modem MDb. The C2K communications protocol may be determined to be used when the modem MDb is turned on, and the C2K communications protocol is determined to be not used when the modem MDb is turned off in this case.

In an embodiment of the present invention, the external module 310 of FIG. 3 may include the foresaid modem MDa and modem MDb so that any of the 2G-4G and C2K protocols is allowed to be used. The modem MDa maybe for supporting the 2G/3G/4G protocols, and the modem MDb may be for supporting the C2K protocol. In FIG. 3, the status information Si may correspond to the protocol used by the external module 310, the status data Sa is updated according to the status information Si so as to generate the updated status data Sa′, the power value Pv and the power allocation Pa are generated accordingly, and the power Pwr is supplied to the external module 310 by the power supply 150. In other words, the power Pwr provided to the external module 310 may be determined according to the communications protocol in used.

FIG. 5 illustrates a power management system 600 according to an embodiment of the present invention. The power management system 600 may include an external module 610 acting as at least a modem MD, an intermediate module 620 including a signal strength storage module 6210, a control module 630 acting as an application processor (AP), a power budget manager 140 and a power supply 150. In FIG. 5, the status information Si may correspond to a signal strength detected by the modem MD. The control module 630 may determine the power value Pv according to the signal strength. The control module 630 (application processor) may determine the power value Pv according to the signal strength by referring a lookup table in the control module 630 or by performing a calculation according to different embodiments of the present invention. Hence, the control module 630 may include at least a lookup table or a calculation unit in different embodiments. The status data Sa may be stored in a plurality of memory units of the intermediary module 620 where the memory units may be included in the signal strength storage module 6210.

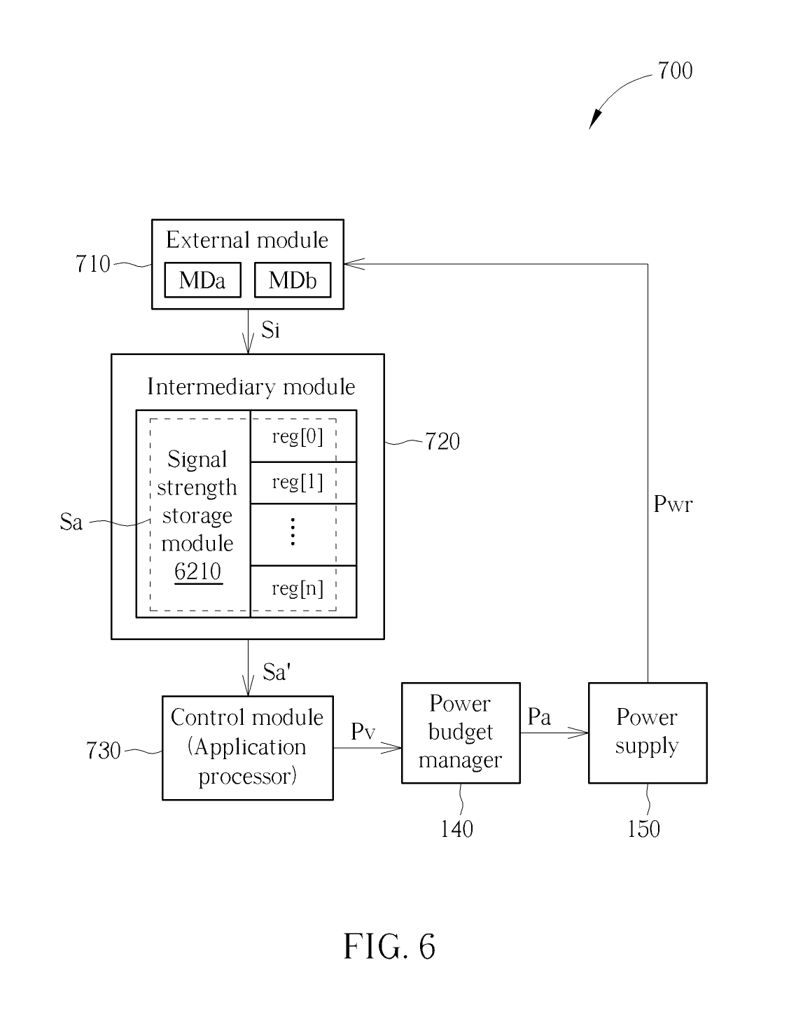

FIG. 6 illustrates a power management system 700 according to an embodiment of the present invention. The power management system 700 may include the external module 710, the intermediate module 720, the control module 730, the power budget manager 140 and the power supply 150. In FIG. 6, the external module 710 may include the foresaid modem MDa (for using the 2G, 3G or 4G wireless communications protocol) and the foresaid modem MDb (for using the C2K protocol). The status information Si may correspond to a communications protocol used by the modems MDa-MDb and a signal strength detected by the modems MDa-MDb. The intermediate module 720 may include the foresaid registers reg[0]-reg[n] (for storing a part of the status data Sa corresponding to the protocol used by the external module 710) and the foresaid signal strength storage module 6210 (for storing another part of the status data Sa corresponding to the detected signal strength) where the signal strength storage module 6210 may include a plurality of memory units. The status data Sa stored in the registers reg[0]-reg[n] and the memory units may be updated according to the status information Si to generate the updated status data Sa′. The control module 730 acting as an AP may determine the power value Pv according to the updated status data Sa′, so the power value Pv may be determined with considering the used communications protocol and detected signal strength.

As mentioned above, the control module 630 of FIG. 5 or the control module 730 of FIG. 6 may include at least a lookup table for determining the power value Pv according to the detected signal strength. The signal strength may be measured in decibel-milliwatts (dBm).

Taking FIG. 6 as an example, the control module 730 may receive the updated status data Sa′ and determine the communications protocol used by the external module 710 and the signal strength detected from the external module 710. The power provided to each of the modems of the external module 710 may be broken into the power amplifier (PA) related power and the RF module related power, and a power breakdown analysis may be performed.

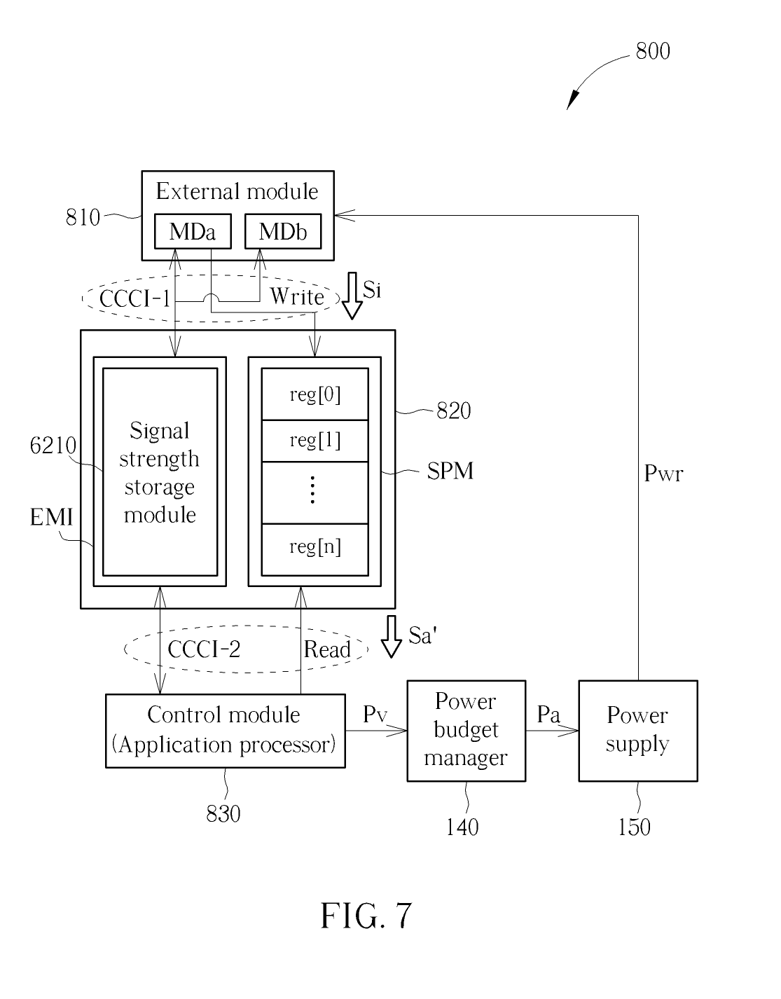

FIG. 7 illustrates a power management system 800 according to an embodiment of the present invention. The power management system 800 is similar to the power management system 700, so the function and operations of the external module 810, the intermediary module 820 and the control module 830 (acting as an AP) are not described repeatedly. Regarding the embodiment of FIG. 7, since the signal strengths detected by the modem MDa (for 2G/3G/4G protocols) and modem MDb (for C2K protocol) needs to be processed, the signal strength storage module 6210 (including memory units) of the intermediary module 820 may be linked to both of the modems MDa and MDb via a CCCI (Content of Communication Control Interface) path CCCI-1. The signal strength storage module 6210 of the intermediary module 820 may also be linked to the control module 830 (via another CCCI path. The said CCCI is an interface designed for linking an AP and a modem supporting bi-directional data transmission. The signal strength storage module 6210 (including memory units) may be designed for being accessed via an EMI (external memory interface). As for the registers reg[0]-reg[n], the register reg[0]-reg[n] may be integrated in an system power manager (SPM) module for the modem MD1 to read via the SPM module, and for the control module 830 to read via the SPM module.

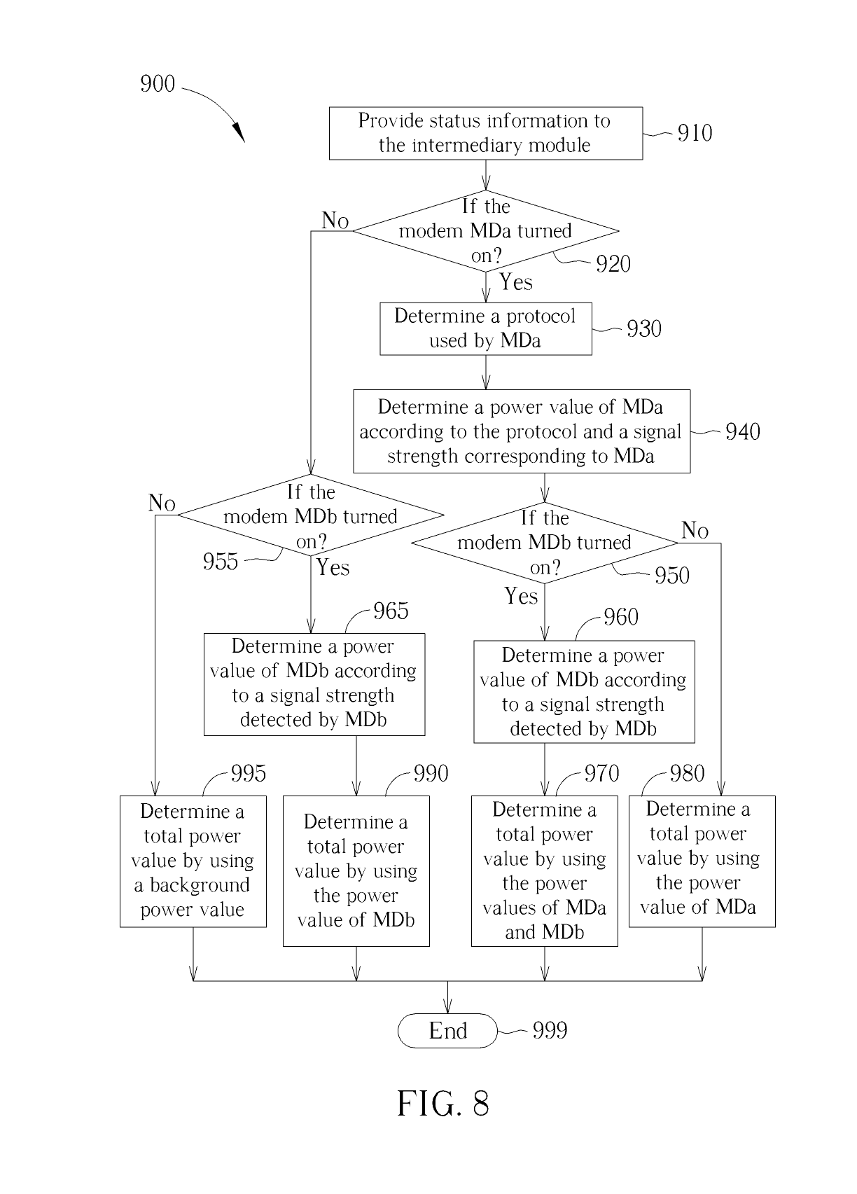

FIG. 8 illustrates a flow chart of a power management method 900 according to an embodiment of the present invention. With referring to the power management system 700 of FIG. 6, the power management method 900 may include the following steps.

Step 910: the external module 710 provides a status information Si to the intermediary module 720;

Step 920: determine whether the modem MDa of the external module 710 is turned on, if so, enter step 930, else enter step 955;

Step 930: determine a communications protocol used by the modem MDa;

Step 940: determine a power value corresponding to the modem MDa according to the communications protocol used by the modem MDa and a signal strength detected by the modem MDa;

Step 950: determine whether the modem MDb of the external module 710 is turned on, if so, enter step 960, else enter step 980;

Step 955: determine whether the modem MDb of the external module 710 is turned on, if so, enter step 965, else enter step 995;

Step 960: determine another power value corresponding to the modem MDb according to a signal strength detected by the modem MDb; enter step 970;

Step 965: determine a power value corresponding to the modem MDb according to a signal strength detected by the modem MDb; enter step 990;

Step 970: determine a total power value by using the power values corresponding to the modems MDa and MDb; enter step 999;

Step 980: determine a total power value by using the power value corresponding to the modem MDa; enter step 999;

Step 990: determine a total power value by using the power value corresponding to the modem MDb; enter step 999;

Step 995: determine a total power value by using a background power value; enter step 999; and

Step 999: end.

In steps 920, 950 and 955, the modem(s) of the external module 710 may be determined to be turned on or not. However, FIG. 6 is taken as an example rather than limiting the scope of the present invention. Taking FIG. 1 as another example, if the external module 110 includes other devices or modules, the devices or modules may be determined to be turned on or not. In addition, the external module 110 may be determined to be turned on or not according to an embodiment of the present invention. In steps 960 and 965, the power value corresponding to the modem MDb may be determined without considering the communications protocol used by the modem MDb since the modem MDb may only use the C2K protocol. In Step 995, since none of the modems MDa and MDb is turned on, the total power value may be a background power value which may be a minimum power value for the system to stay alive. In step 970, the total power value may be (but not limited to) a value obtained by adding the power values corresponding to the modem MDa and MDb. Other algorithms, formulas or lookup tables may be used according to other embodiments of the present invention.

Referring to FIG. 1, according to another embodiment of the present invention, if the external module 110 is turned on, it may be determined if the status data Sa is to be updated according to the status information Si or according to a maximum power consumption of the external module 110. If the status data Sa is updated according to a maximum power consumption of the external module 110, the effect of saving power consumption would be worse, but the external module 110 would be guaranteed to operate with sufficient power supply.

In summary, by using the power management method and power management system disclosed by the embodiments of the present invention, the operating scenarios such as used communications protocol(s) and detected signal strength(s) may be well considered for generating a power value, and a power allocation may be determined according to at least the power value. Not only the device standby time can be extended, but the system performance can also be improved because the power can be better allocated, and other functional unit (e.g. a central processing unit or a graphics processing unit) can be supplied with more sufficient power.

Hence, by using the method and system disclosed by the present invention, the effect of saving power consumption, improving power management and enhancing system performance can be significant.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power management method comprising:
accessing updated status data via an intermediary module;
determining a power value according to the updated status data;
determining power allocation according to at least the power value; and
providing power to the external module according to the determined power allocation;
wherein the updated status data corresponds to status information provided by an external module.

2. The power management method of claim 1, wherein the external module is a modem.

3. The power management method of claim 2, wherein the intermediary module comprises a plurality of registers and/or a plurality of memory units for hand-shaking and data storage.

4. The power management method of claim 1, wherein the status information corresponds to a communications protocol used by the external module.

5. The power management method of claim 4, wherein the communications protocol used by the external module is a second-generation wireless communications protocol, a third-generation wireless communications protocol, or a fourth-generation wireless communications protocol.

6. The power management method of claim 4, wherein the communications protocol used by the external module is a CDMA2000 protocol.

7. The power management method of claim 4, wherein the status data is stored in a plurality of registers of the intermediary module.

8. The power management method of claim 1, wherein the status information corresponds to a signal strength detected by the external module.

9. The power management method of claim 8, wherein the control module determines the power value according to the signal strength by referring a lookup table.

10. The power management method of claim 8, wherein the control module determines the power value according to the signal strength by performing a calculation.

11. The power management method of claim 8, wherein the status data is stored in a plurality of memory units of the intermediary module.

12. The power management method of claim 1, wherein the status information corresponds to a communications protocol used by the external module and a signal strength detected by the external module.

13. The power management method of claim 12, wherein the communications protocol used by the external module is a second-generation wireless communications protocol, a third-generation wireless communications protocol, or a fourth-generation wireless communications protocol.

14. The power management method of claim 12, wherein the control module determines the power value according to the communications protocol used by the external module and according to the signal strength by referring a lookup table.

15. The power management method of claim 12, wherein the control module determines the power value according to the communications protocol used by the external module and according to the signal strength by performing a calculation.

16. The power management method of claim 12, wherein status data corresponding to the communications protocol is stored in a plurality of registers of the intermediary module and status data corresponding to the signal strength is stored in a plurality of memory units of the intermediary module.

17. The power management method of claim 1, further comprising determining if the external module is turned on.

18. The power management method of claim 17, further comprising if the external module is turned on, determining if the status data is to be updated according to the status information or according to a maximum power consumption of the external module.
